(19) United States
(12) Patent Application Publication
(10) Pub. No.: US 2018/0050422 A1
(43) Pub. Date: Feb. 22, 2018

(54) METHOD FOR MANUFACTURING COMPRESSOR COMPONENTS

(71) Applicant: Solar Turbines Incorporated, San Diego, CA (US)

(72) Inventor: Jason Wing-bin Fong, San Diego, CA (US)

(73) Assignee: Solar Turbines Incorporated, San Diego, CA (US)

(21) Appl. No.: 15/242,258

(22) Filed: Aug. 19, 2016

(51) Int. Cl. B23K 26/342; B33Y 10/00; B33Y 80/00; B23K 26/144; B23K 26/70; F04D 17/10; F04D 29/08

(52) U.S. Cl. CPC B23K 26/342; B33Y 10/00; B33Y 80/00; B23K 26/144; B23K 26/702; F05B 2230/234; F04D 29/083; F05B 2240/14; F05B 2240/12; F05B 2240/50; F05B 2240/57; F04D 17/10

(57) ABSTRACT

A method forming a metallic structure having two or more portions is provided. The method can include providing a first layer of metal-forming material and then applying energy of a first power level to a first area of the first layer of metal-forming material to form a first portion of the metallic structure having a first density. Energy of a second power level can then be applied to a second area of the first layer of metal-forming material to form a second portion of the metallic structure having a second density. A second layer of the metal-forming material can be applied on top of the first portion and the second portion. The energy of the first power level can be applied to a first area of the second layer of metal-forming material and the energy of the second power level can be applied to a second area of the second layer to form the metallic structure.

### TECHNICAL FIELD

The present disclosure generally pertains to fabrication of certain engine or compressor components. More particularly, this disclosure to forming certain components, for example, a labyrinth seal, for use within a centrifugal gas compressor.

### BACKGROUND

Gas compressors exist in various forms and can have separated drive and compressor coupled by a drive shaft. Some related examples include, integrated hydroelectric generators, wind turbines with hub generators, etc. For pressurized devices such as compressors, several seals can be used to seal the shaft and various compressor stages from each other and from the atmosphere. Magnetic bearings may support moving machinery without physical contact. For example, they can levitate a rotating shaft, providing for rotation with very low friction and no mechanical wear. However in order to provide compression of a working fluid (e.g., air or other gaseous compounds) multiple seals may be needed between compressor stages and between the compressor and the atmosphere. Such seals can be low friction mechanical seals with a tortious path from inlet to outlet to prevent leakages. An example of such a tortious mechanical seal is a labyrinth seal.

A labyrinth seal may be comprised of many grooves that press tightly inside another axle, or inside a hole, so that the working fluid has to pass through a long and difficult path to escape. The grooves interlock, to produce the long characteristic path which slows leakage. For labyrinth seals on a rotating shaft such as in a compressor, a very small clearance must exist between the tips of the labyrinth threads and the running surface.

Labyrinth seals on rotating shafts provide non-contact sealing action by controlling the passage of fluid through a variety of chambers by centrifugal motion, as well as by the formation of controlled fluid vortices. At higher speeds, centrifugal motion forces the liquid towards the outside and therefore away from any passages. Similarly, if the labyrinth chambers are correctly designed, any working fluid that has escaped the main chamber becomes entrapped in a labyrinth chamber, where it is forced into a vortex-like motion. This acts to prevent its escape, and also acts to repel any other fluid.

Labyrinth seals can be difficult to manufacture, given the nature of the materials and the construction of their various surfaces. The present disclosure is directed toward overcoming one or more of the problems discovered by the inventors or that is known in the art.

### SUMMARY

An aspect of the disclosure provides a method for forming a metallic structure having two or more portions. The method can include providing a first layer of metal-forming material. The method can also include applying energy of a first power level to a first area of the first layer of metal-forming material to form a first portion of the metallic structure having a first density. The method can also include applying energy of a second power level to a second area of the first layer of metal-forming material to form a second portion of the metallic structure having a second density. The method can also include providing a second layer of the metal-forming material on top of the first portion and the second portion of the metallic structure. The method can also include applying the energy of the first power level to a first area of the second layer of metal-forming material. The method can also include applying the energy of the second power level to a second area of the second layer of metal-forming material.

Another aspect of the disclosure provides a method for making a labyrinth seal for use in an internal-driven compressor, the labyrinth seal having a cylindrical body, an integral open cell structure, and a filler media within the open cell structure. The method can include providing a first layer of metallic powder. The method can also include applying laser energy of a first power level to a first area of the first layer of metallic powder to form a first portion of the cylindrical body having a first weld strength. The method can also include applying laser energy of a second power level to a second area of the first layer of metallic powder to form a first portion of the open cell structure having a second weld strength. The method can also include applying laser energy of a third power level to a third area of the first layer of metallic powder to form a first portion of the filler material having a third weld strength. The method can also include providing a second layer of metallic powder on top of the first portions of the cylindrical body, the open cell structure, and the filler media. The method can also include applying laser energy of the first power level to a first area of the second layer of metallic powder to form a second portion of the cylindrical body. The method can also include applying laser energy of the second power level to a second area of the second layer of metallic powder to form a second portion of the open cell structure. The method can also include applying laser energy of the third power level to a third area of the second layer of metallic powder to form a second portion of the filler material.

Another aspect of the disclosure provides a labyrinth seal prepared by a process. The process can include providing a first layer of metal-forming material. The process can also include applying energy of a first power level to a first area of the first layer of metal-forming material to form a first portion of the metallic structure having a first density. The process can also include applying energy of a second power level to a second area of the first layer of metal-forming material to form a second portion of the metallic structure having a second density. The process can also include providing a second layer of the metal-forming material on top of the first portion and the second portion of the metallic structure. The process can also include applying the energy of the first power level to a first area of the second layer of metal-forming material. The process can also include applying the energy of the second power level to a second area of the second layer of metal-forming material.

Other features and advantages will become clear with a review of the following description.

### BRIEF DESCRIPTION OF THE DRAWINGS

FIG. 1 is a perspective view of an exemplary internal-driven compressor.

FIG. 2 is a cross sectional side view of a portion of the internal-driven compressor of FIG. 1.

FIG. 3 is a perspective view of a labyrinth seal of the internal-driven compressor of FIG. 1.

FIG. 4 is a cross sectional side view of the labyrinth seal of FIG. 3.

FIG. 5 is a detailed side view of a portion of an embodiment of the labyrinth seal of FIG. 4.

FIG. 6 is a detailed side view of a portion of another embodiment of the labyrinth seal of FIG. 4.

FIG. 7 is a flowchart of a method for manufacturing the labyrinth seal of FIG. 3.

### DETAILED DESCRIPTION

The present disclosure relates to a centrifugal gas compressor. Embodiments provide an internal-driven compressor that integrates the motor (e.g., electric motor) within the compressor itself. Other embodiments can have a separated compressor and driver or motor. While a gas compressor with an integrated motor may be used as a primary example herein, the disclosure is also applicable to systems with a separated compressor and motor or drive system. Other embodiments can include other types of mechanical systems and associated components. The compressor rotor can be rotatably mounted on a fixed central axle of a compressor bearing system. The impeller is driven by an electric motor rotor imbedded in the impeller bore surface. In addition, the electric motor is axially located between radial bearings.

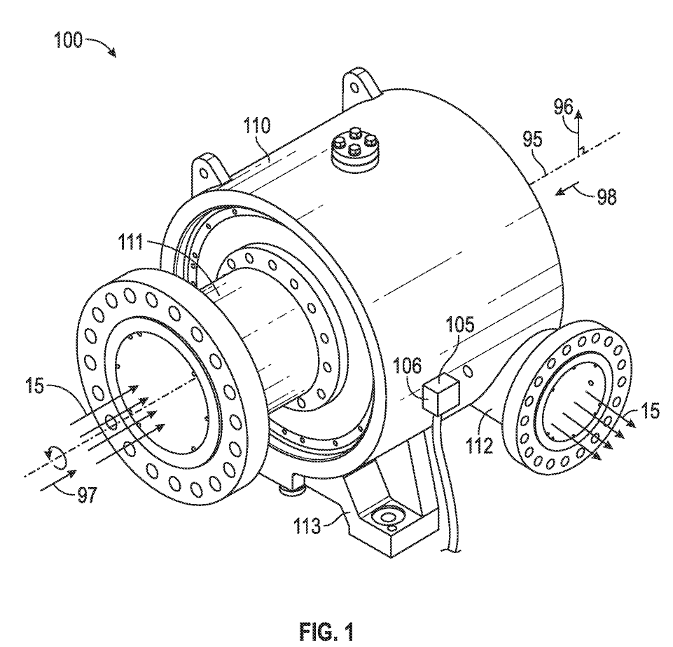

FIG. 1 is a perspective view of an exemplary internal-driven compressor. In particular, the illustrated internal-driven compressor 100 is embodied as an axially-fed, industrial centrifugal gas compressor having a side discharge. However, this particular configuration is merely for illustration purposes, as the illustrated internal-driven compressor 100 can include any combination of singular or plural, axial, linear, and radial feeds and discharges. Likewise, the present disclosure may be applied to other types of pumps, compressors, and the like. Here and in other figures, various components and surfaces have been left out or simplified for clarity purposes and ease of explanation.

For reference, the internal-driven compressor 100 generally includes a center axis 95 about which its primary rotating components rotate. The center axis 95 may be common to or shared with various other components of the internal-driven compressor 100. All references to radial, axial, and circumferential directions and measures refer to center axis 95, unless specified otherwise, and terms such as “inner” and “outer” or “inward” and “outward” generally indicate a lesser or greater radial distance from the center axis 95, wherein a radial 96 may be in any direction perpendicular and radiating outward from center axis 95.

In addition, this disclosure may reference a forward and an aft direction. Generally, all references to “forward” and “aft” are associated with a flow direction, relative to the center axis 95, of the compressed gas. In particular, the suction end 97 (inlet) of the internal-driven compressor 100, relative to the center axis 95 is referred to as the forward end or forward direction. Accordingly, the opposite end or discharge end 98 is referred to as the aft end or direction, unless specified otherwise.

Externally, the internal-driven compressor 100 includes a compressor housing 110 and an external power supply interface 105 and a communication interface 106. Here, the communication interface 106 is illustrated as combined with the external power supply interface 105 for convenience; however, the communication interface 106 may be embodied as separate from the external power supply interface 105.

Generally, the compressor housing 110 encloses and supports internal components of the internal-driven compressor 100. Also, unlike a conventional shaft-driven compressor (requiring a dynamic seal), the external power supply interface 105 and the communication interface 106 may be statically sealed to compressor housing 110.

Additional controls for the internal-driven compressor 100 may be integrated into the internal-driven compressor 100 and/or located remotely. Moreover, communications, feedback, and control for the internal-driven compressor 100 may be interfaced independently, as discussed above. Alternately, communications, feedback, and control for the internal-driven compressor 100 may be interfaced via the external power supply interface 105.

The compressor housing 110 can have a suction port 111 and a discharge port 112. The suction port 111 interfaces with a fluid supply (not shown), and is configured to supply a fluid (e.g. working gas, working fluid, process gas, pumped fluid, etc.) to the internal-driven compressor 100. Here, the fluid is a gas 15. Similarly, the discharge port 112 interfaces with a fluid discharge (not shown), and is configured to discharge the gas 15 from the internal-driven compressor 100. The compressor housing 110 may also include support legs 113, or other features to secure or physically ground the internal-driven compressor 100.

The external power supply interface 105 may include power conduit and associated power control devices configured to provide power from an external supply (not shown) into the internal-driven compressor 100. For example, the external power supply interface 105 may include electrical conduit and accessories conventionally associated with an electrical supply. Alternately, the external power source may be hydraulically or pneumatically based.

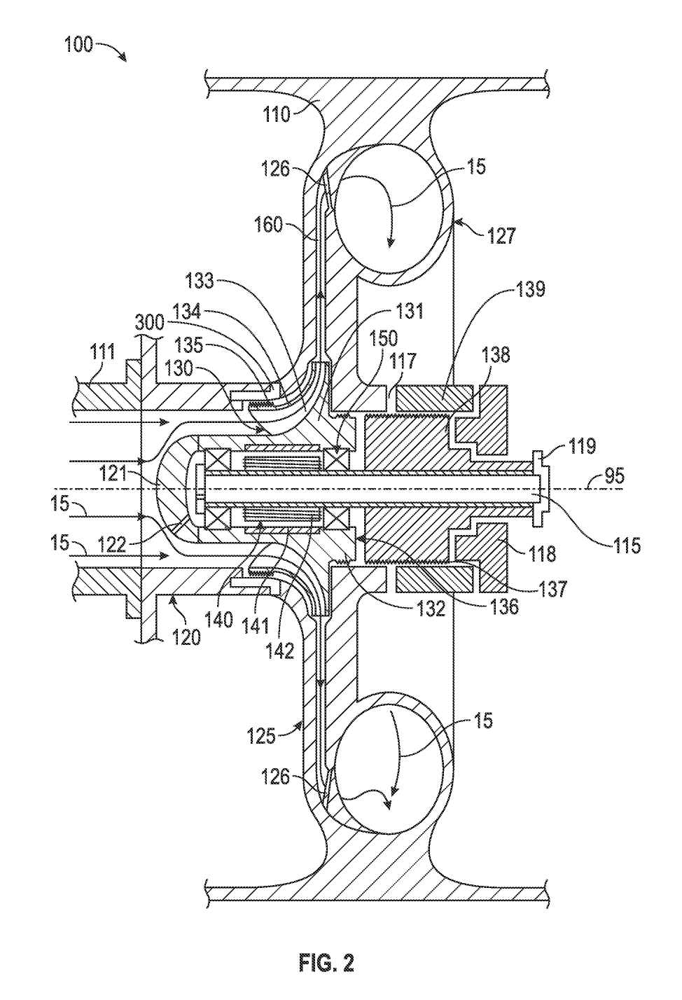

FIG. 2 is a cross sectional view of an embodiment of the internally driven compressor of FIG. 1. The compressor 100 can have multiple compressor stages, however only a single compressor stage is shown for illustrative purposes. As above, various components and surfaces may have been left out, cut away, and/or simplified for clarity purposes and ease of description. As shown, the gas 15 enters the internal-driven compressor 100 axially, is compressed in a single stage, and is subsequently collected and discharged.

Internally, the internal-driven compressor 100 includes a central axle 115, a compressor inlet 120, a compressor outlet 125, a powered compressor rotor 130, an internal driver 140, and a compressor bearing system 150. The internal driver 140 and the compressor bearing system 150 are configured to drive and support the powered compressor rotor 130 about the center axis 95, respectively. The powered compressor rotor 130 rides in a cavity within the compressor housing 110. In addition, the internal driver 140, and the compressor bearing system 150 are enclosed within the compressor housing 110. According to an embodiment, the internal-driven compressor 100 may include a powered compressor rotor assembly including portions of the powered compressor rotor 130 and the internal driver 140 coupled to the central axle 115. Moreover, the powered compressor rotor assembly may contain portions of the compressor bearing system 150.

The powered compressor rotor 130 makes up a single compression stage (as discussed below, additional stages may be used). The internal-driven compressor 100 may further include a diffuser 160 downstream of the powered compressor rotor 130. Thus, the gas 15 compressed by the powered compressor rotor 130 may then be diffused by the diffuser 160.

The compressor inlet 120 includes an upstream opening in the compressor housing 110 configured to introduce the gas 15 into the compressor flow path within the compressor housing 110. The compressor flow path may be bound in part by the compressor housing 110 (or additional structures within the compressor housing 110), and in part by the powered compressor rotor 130. Here the compressor inlet 120 is configured as an axial inlet; however, as illustrated below, in other embodiments the compressor inlet 120 may be configured as a radial or side inlet.

The compressor inlet 120 may generally include the suction port 111 and any flow distributing/shaping features downstream of the suction port 111 and upstream of the powered compressor rotor 130. For example, these features may include struts, vanes, ducting, in-line filters, etc. Also for example, the compressor inlet 120 may include a nose cover 121. The nose cover 121 is an aero structure at the upstream end of the powered compressor rotor 130 configured to direct and condition flow entering the compression flow path. The nose cover 121 may also be configured to seal internal components from the gas, particularly where the powered compressor rotor 130 is supported by a cantilever and the compressor inlet 120 is configured as an axial inlet. The nose cover 121 may be fixed to the powered compressor rotor 130, as illustrated. Alternately, the nose cover 121 may be fixed to a structure inside the powered compressor rotor 130 (e.g., the central axle 115) or to a portion of the compressor housing 110.

The compressor outlet 125 includes a downstream opening (not shown in this view) in the compressor housing 110 configured to discharge the gas 15 from the compressor housing 110. For example, the downstream opening may be defined by the interface between the compressor housing 110 and the discharge port 112 (FIG. 1). Moreover, the compressor outlet 125 may generally include the discharge port 112 and any upstream flow distributing/shaping features. These upstream flow distributing/shaping features may include struts, vanes, ducting, etc. upstream of the discharge port 112 and downstream of the powered compressor rotor 130 or the diffuser 160. According to an embodiment, the compressor outlet 125 may include a plurality of outlet vanes 126 radially distributed about the center axis 95, downstream of the powered compressor rotor 130. The plurality of outlet vanes 126 may be configured to reduce swirl in the gas 15 imparted by the powered compressor rotor 130.

Here, the compressor outlet 125 is configured as a radial or side outlet. Thus, the compressor outlet 125 may also include a collector 127 at its upstream end. The collector may be integrated into the compressor housing 110, or may be joined to it as discrete unit. The collector 127 forms part of the compressor flow path, receiving the gas 15 in a radial flow and discharging the gas 15 in a linear direction. In addition, the plurality of outlet vanes 126 may be positioned and distributed at an upstream end of the collector. According to one embodiment, the collector 127 may be embodied as a discharge volute. The discharge volute is a curved funnel that increases in area as it approaches with the discharge port 112.

According to one embodiment, the powered compressor rotor 130 may be a powered impeller, having portions of the internal driver 140 embedded into or otherwise fixed to the powered impeller. In particular, the powered impeller may include a rotor 141 of the internal driver 140 embedded or otherwise fixed to the powered impeller. Thus, no drive shaft, or the like, is between the powered impeller and rotor 141 of the internal driver 140.

The powered impeller may include an annular body 131 having an impeller bore surface 132, and a series of impeller vanes 133 about an impeller axis. The annular body 131 includes an opening or impeller bore about the impeller axis. The center axis 95 may be shared or common to the impeller axis (hereinafter center axis 95) when installed. Additional features of the powered impeller may be integrated in or otherwise extend from the annular body. In some embodiments the bore of annular body may be closed at one or more locations along the center axis 95.

The impeller bore surface 132 is an inner surface of the powered impeller, circumscribing the center axis 95. Moreover, the impeller bore surface 132 may include one or more grooves, notches, slots, or other departures from a regular (e.g., cylindrical) surface, such that one or more components may be fixed to, or features may be added to the powered compressor rotor 130. For example, the impeller bore surface 132 may include a departure from a regular surface of rotation (e.g., cutout, cavity, groove, etc.), such that it is configured to engage the rotor 141. Likewise, portions of the rotor 141 may be embedded in the departure from the regular surface of rotation.

Where the internal driver 140 is an electric motor rotor, the rotor 141 may be engaged (or fixed to and located) to the impeller bore surface 132, or another portion of the annular body 131. Being fixed directly to the annular body 131, the rotor 141 is thus configured to rotate its impeller vanes 133 about the center axis 95 in direct response to an electromotive force imparted by the stator 142 of the internal driver 140. In this case, the stator 142 of the internal driver 140 is located radially inward of the rotor 141, and may be embedded or otherwise fixed to a central axle 115.

Additionally, the series of impeller vanes 133 may include flow motion transmission surfaces extending from the annular body 131. The series of impeller vanes 133 may be configured to compress and/or redirect the gas 15 along the compression flow path. For example, here, the series of impeller vanes 133 are configured to compress an axial flow of gas while redirecting it into a radial flow.

Furthermore, and as illustrated, the powered impeller may be a covered or enclosed impeller. Thus, the series of impeller vanes 133 may be part of a series of ducted vanes. The series of ducted vanes includes a shroud 134 around the series of impeller vanes 133 underneath. Accordingly, a portion of the compression flow path will be bounded by the ducted vanes and the surface of the annular body 131 between each impeller vanes 133. The shroud 134 and the series of impeller vanes 133 may be integrated as a single unit along with the annular body 131, extending inward to the impeller bore surface 132.

In this embodiment, the powered compressor rotor 130 may also include one or more seals between the compressor housing 110 and the powered impeller. The one or more seals are configured to impede the gas 15 from bypassing or flowing other than through the compressor flow path of the ducted vanes. For example, the powered compressor rotor 130 may include one or more dry seals, such as, for example, a labyrinth seal 300. The labyrinth seal 300 can interact with labyrinth teeth 135 located on an outer circumference of the powered compressor rotor 130 proximate its upstream end. The labyrinth teeth 135 and labyrinth seal 300 can be a dry seal, formed by the interaction between the labyrinth teeth 135 and the labyrinth seal 300. The labyrinth teeth 135 can be machined, formed into, or otherwise fixed to the shroud 134. Alternately, one or more similar labyrinth seals may be machined, formed into, or otherwise fixed to the compressor housing 110. The labyrinth seal 300 can be machined or otherwise formed as a user-replaceable component that surrounds or encompasses the labyrinth teeth 135. In some examples, the labyrinth seal 300 can also be referred to as a shroud seal, depending on the location of the seal within the internal-driven compressor 100.

Also in this embodiment, the powered compressor rotor 130 may further include an impeller hub 136. The impeller hub 136 may be located at a downstream end of the powered compressor rotor 130 (i.e., axially towards the discharge end 98). The impeller hub 136 may include hub teeth and be positioned proximate a piston head 138 having head teeth 137. The hub teeth and the head teeth 137 can also be similar to the labyrinth teeth 135 and interact with a shrouded structure similar to the labyrinth seal 300 to complete the dry seal. For example, a balance piston seal 139 can interact with the head teeth 137 to form a labyrinth seal or shroud seal.

The head teeth 137 can have a similar configuration to the labyrinth teeth 135 and have a seal housing similar to the labyrinth seal 300. The piston head 138 may have an effective area generally defined by the annular region between its diameter and the diameter of the impeller bore surface 132 at the downstream end of the powered impeller.

The balance piston cavity 117 is ported to a lower pressure supply (e.g., upstream the powered impeller, ambient, etc.). In particular, due to the pressure rise developed through the powered impeller, a pressure difference exists such that a net thrust is created in the upstream direction. By subjecting the piston head 138 to the lower pressure supply, a pressure differential opposite to the direction of the net thrust is created. For example, the balance piston cavity 117 may be ported via a series of openings 122 (e.g., through the nose cover 121 and portions of the central axle 115) that create a flow path between a low pressure area (inlet pressure) and the balance piston cavity 117.

According to an embodiment, the internal-driven compressor 100 may support the internal driver 140 and the compressor bearing system 150 via the central axle 115. Moreover the powered compressor rotor 130 may be rotatably mounted to the central axle 115, such that the powered compressor rotor 130 may rotate about the center axis 95. The central axle 115 is then supported by the compressor housing 110. For example, here, the central axle 115 is nonrotatably fixed to the compressor housing 110 and is cantilevered from an endcap 118 located its aft end. Alternately, the central axle 115 may be supported from both its forward and aft ends (e.g., where the internal-driven compressor 100 includes radial feed and discharge, and two endcaps). Also for example and as illustrated, the central axle 115 may include a cylindrical outer diameter.

Generally, the central axle 115 includes a member fixed to the compressor housing 110 at one or more locations. For example, the central axle 115 may include a member concentric with the center axis 95 and fixed to the compressor housing 110 at its aft and/or forward ends. Also for example, the central axle 115 may be solid, hollow, symmetrical, and/or asymmetrical. Accordingly, the central axle 115 may have a cylindrical shape, and be positioned in a location similar to that of a conventional drive shaft. However, unlike a conventional drive shaft, penetrating its respective compressor housing and operating at a high rotation speed, the driver central axle 115 may reside completely within the compressor housing 110, or at least be substantially sealed within the compressor housing 110.

According to one embodiment, the central axle 115 may be hollow or include hollow portions. In particular, the central axle 115 may include one or more passageways through which power, control, cooling, pressure equalization, etc. may be provided to or within the internal-driven compressor 100. For example, the central axle 115 may have a generally tubular shape. In addition, the central axle 115 may include an access port 119 at the endcap 118. As such, the external power supply interface 105 may be statically sealed at the access port 119, and power and signal cables may be routed through the fixed central axle 115. Also for example, the central axle 115 may ported such that equalization pressure may reach the balance piston cavity 117.

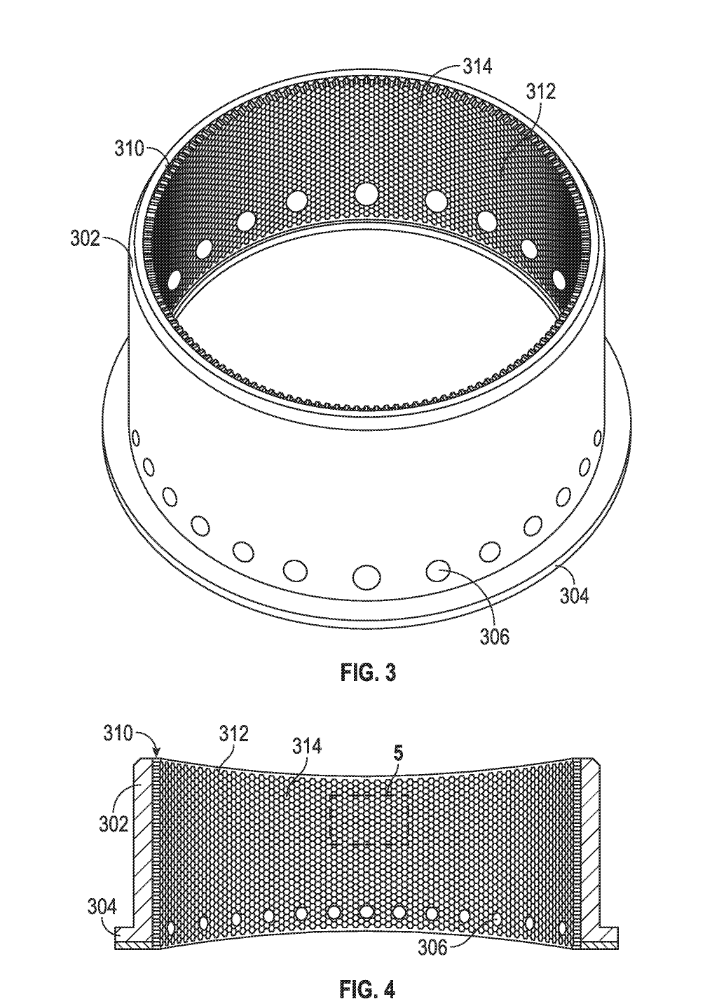

FIG. 3 is a perspective view of an embodiment of the labyrinth seal of FIG. 2. The labyrinth seal 300 can have an overall cylindrical body 302 formed to fit in one or more locations within the internal-driven compressor 100. For example, the labyrinth teeth 135 can have the labyrinth seal 300. The balance piston seal 139 (FIG. 2) can also have an embodiment of the labyrinth seal 300 to form a dry seal such as a labyrinth seal.

The labyrinth seal 300 can have seal media 310 formed on the interior of the cylindrical body 302. The seal media 310 can have one or more abradable components or substructures that interact with a plurality of circumferential teeth, e.g., the labyrinth teeth 135. The labyrinth teeth 135 are shown in the cross section of FIG. 2 with the labyrinth seal 300 and can form grooves in the seal media 310 with the rotation of the compressor rotor 130. The labyrinth teeth 135 can abrade the seal media and form grooves on within the seal media 310 that then interlock with the labyrinth teeth 135 to produce a long path or “labyrinth” that slows or prevents leakage. Accordingly, a portion of the seal media 310 is sacrificial as it is worn away by the labyrinth teeth 135 to create the interlocking grooves or labyrinth. For example, on a rotating shaft, a very small clearance exists between the tips of the labyrinth teeth 135 and the running surface of the seal media 310.

FIG. 4 is a cross section of the labyrinth seal 300 of FIG. 3. In some embodiments, the seal media 310 can be formed of one or more substructures. In some examples, the cylindrical body 302 can be machined or formed to have a circumferential lip 304 or other features such as a plurality of apertures 306. The apertures 306 can be present to allow, for example, bleed air to penetrate the cylindrical body 302 to increase the rotational stability of the compressor rotor 130 or other purposes. The seal media 310 can also have an open cell structure 312. The open cell structure 312 can be formed separately from the cylindrical body 302 and attached thereto via various welding processes, such as brazing, for example. The open cell structure 312 can be a honeycomb, another repeating pattern, or other structure having a plurality of open cells.

In some examples, the open cell structure 312 can have a plurality of cavities 314 within the open cells. The cavities 314 be filled with a powdered metal and then baked to solidify and harden the powdered metal within the open cell structure. The open cell structure 312 and the baked and hardened metal powder can then form the seal media 310. In some embodiments, the cylindrical body 302 and the seal media 310 can also be formed in successive layers by hardening or welding a metal-forming material (e.g., powdered metal) using varying energy levels on specific portions of the layers of powdered metal. For example, a laser can be used to weld specific portions of each layer of the powdered metal for form a given structure, such as the labyrinth seal 300. In some embodiments, the seal media 310 may have only the open cell structure 312 without filling the cells with the metallic powder. In some other embodiments, the seal media 310 can be a solid material without the open cell structure 312. In some embodiments, the powdered metal can be, for example, an Incol-based alloy, HastX (e.g., Hastelloy X), 17-4, or 316SS stainless steel. The skilled person will appreciate that other materials are also compatible with such a use.

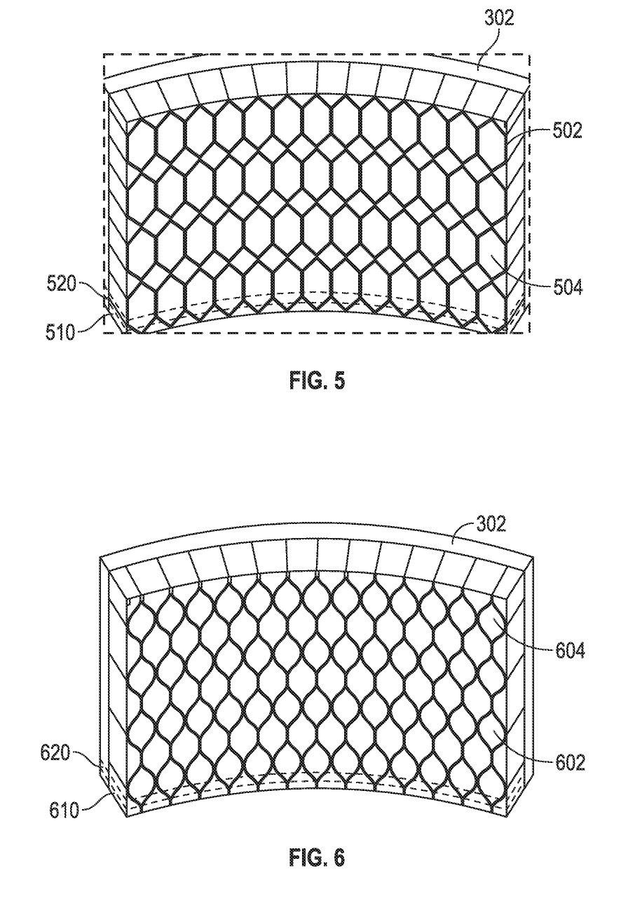

FIG. 5 is a detailed view of a portion of an embodiment of the labyrinth seal of FIG. 4. The portion of the labyrinth seal 300 shown has an open cell structure 502. The open cell structure 502 can be a repeating geometric pattern, such as the pattern shown. The open cell structure 502 can also be other patterns such as a honeycomb pattern, or a mesh pattern comprising a repeating polygon, such as for example, a hexagon or a square. The open cell structure 502 can provide an amount of rigidity to the seal media 310.

In some embodiments, the open cell structure 502 can have a media filler 504 filling the open cells of the open cell structure 502 (e.g., the cavities 314 of FIG. 4). The media filler 504 can have a different consistency, a different hardness, and/or a different density than that of the open cell structure 502. Similarly, the portion of the cylindrical body 302 shown can have density and hardness that is different from the open cell structure 502 and the media filler 504. In some examples, the cylindrical body 302 can be the hardest or have the highest weld strength of the three components, followed by the open cell structure 502, and then the media filler 504, if present. The skilled person should appreciate that other combinations or structures are also possible having varying characteristics.

As noted above, the labyrinth seal 300 can be formed using more than one individual component. In some examples, the cylindrical body 302 can be milled or cast from a first material. The open cell structure 312 (FIG. 4) can be formed from a second material and brazed or otherwise secured to the cylindrical body 302. The resulting structure is an embodiment of the labyrinth seal 300 usable with the labyrinth teeth 135 as described above.

In some other examples, the cavities 314 can be filled with, for example, a powered metallic substance and baked or otherwise processed such that the powder metallic substance solidifies. The powered metal then forms a solid material that fills the cavities 314 of the open cell structure 312. The resulting structure is another embodiment of the labyrinth seal 300 usable with the labyrinth teeth 135.

In some embodiments of the disclosure, the labyrinth seal 300 can be formed in successive layers. For example, a first layer 510 of a metal-forming material (e.g., metallic powder or powdered metal) can be subjected to different energy levels from, for example, a laser. In a similar way that baking solidifies and hardens the metallic powder packed into the cavities 314, application of laser energy at different power levels can result in different weld strengths, hardnesses, and/or different densities of the same metallic powder or similar material in a given layer (e.g., the first layer 510) of the labyrinth seal 300, for example. As used herein, weld strength can refer to the strength of the bond between adjacent metallic particles. In some examples, application of higher energy laser will result in adjacent metallic particles melting together to create a solid piece of metal. Lower energy application can result in lower weld strength resulting in a porous or not completely bonded structure. For example, the powder used to form the cylindrical body 302 may be heated to form a very hard structure. The cylindrical body 302 may be the main structural component of the labyrinth seal 300 so it may require the hardest material. The open cell structure 502 may be the same hardness or a different hardness than cylindrical body 302, for example, as portions of it may be abraded by the labyrinth teeth 135 when installed and in use. The teeth of the labyrinth teeth 135 can cut through open cell structure 502 to create the labyrinth of the labyrinth teeth 135, as described above.

In another embodiment having the filler material 504, a third energy level can be applied to the layer of filler material 504. Accordingly, with each successive layer, such as the first layer 510 and a second layer 520, a structure with multiple hardnesses, densities, or weld strengths within each layer can be formed in successive layers. This can simplify, for example, the casting, brazing, baking, and machining, that is needed to form the labyrinth seal 300, or another metallic component. This can dramatically decrease the complexity of fabricating certain components.

FIG. 6 is a detailed view of a portion of another embodiment of the labyrinth seal of FIG. 4. A section 600 can be formed in a similar manner as the portion 500. The portion 600 has an open cell structure 602. As shown, a different geometric pattern can be implemented for the open cell structure 602. The portion 600 can also have a filler media 604. However, the filler media 604 may not be required for proper functioning of the labyrinth teeth 135 in conjunction with the labyrinth seal 300.

The portion 600 can be formed in layers similar to the portion 500. Once a first layer 610 is laid down, laser energy can be applied to form the cylindrical body 302 and the open cell structure 602. As shown, the first layer 610, denoted by a dashed line, has a portion of the cylindrical body 302 and portions of both the open cell structure 602 and the filler media 604, each with a different weld strength. The different weld strengths needed for different areas of the portion 600 can be achieved by varying the energy levels applied to those areas.

A second layer 620 can be formed on top of the first layer 610 using the metal-forming material. The metal-forming material can be welded in portions corresponding to desired structure (e.g., the labyrinth seal 300). Accordingly, the labyrinth seal 300 can be formed using multiple layers of metallic powder or other materials that solidify with application of varying laser power levels.

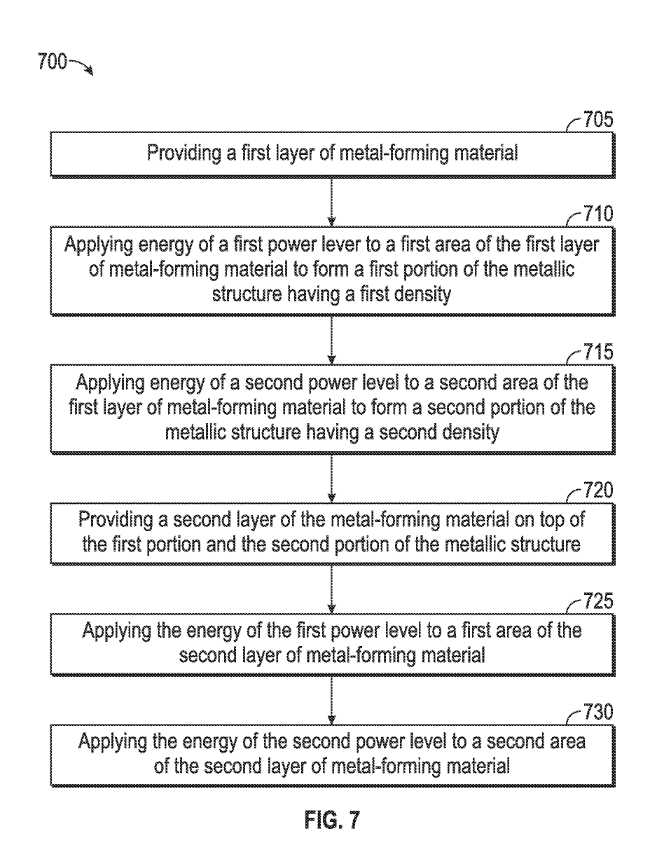

FIG. 7 is a flowchart of a method for using multiple power levels to create a metallic component having multiple densities. A method 700 can be used to form, for example, the labyrinth seal 300 (FIG. 3). The method 700 can begin at block 705 when a first layer of metal-forming material can be provided. In some examples, the metal-forming material can be a layer of powdered metal or similar material. The first layer of metal-forming material (or powdered metal) can be similar to the first layer 510 (FIG. 5) or the first layer 610 (FIG. 6).

At block 710, the method 700 can include applying energy of a first power level to a first area of the first layer of metal-forming material to form a first portion of the metallic structure having a first density. The energy can be imparted by a laser or other heating element than can melt or weld adjacent metallic particles together. Different energy levels can produce different weld strengths between the particles of powdered metal. For example, higher energy can create a more complete weld or a more dense metal form. Accordingly, the amount of energy applied to the metal-forming material can determine how hard the resulting metal structure becomes. In some examples, the first portion of the metallic structure can be the cylindrical body 302. In some other examples, the first portion of the metallic structure can also be the cylindrical body 302 coupled to the open cell structure 312.

At block 715 the method 700 can include applying energy of a second power level to a second area of the first layer of metal-forming material to form a second portion of the metallic structure having a second density. Similar to the process of block 710, the energy imparted can be from a laser, welding the adjacent metal particles together to form the second portion of the first layer. Again the first layer in blocks 710, 715 can be similar to the first layer 510 or the layer 610. As described in connection with block 710, the first portion of the metallic structure can be the cylindrical body 302. In such an example, the second portion of the metallic structure can be the open cell structure 312, for example. Accordingly, the cylindrical body 302 and the open cell structure 312 can have different weld strengths, hardnesses, or densities.

Also noted above, the cylindrical body 302 and the open cell structure 312 can both be the first portion of the metallic structure. Thus, in such an example, the second portion of the metallic structure (having the second weld strength) can also be the media filler 504 (FIG. 5) within the cavities 314. In still other examples, all three components (e.g., the cylindrical body 302, the open cell structure 312, and the media filler 504) can each have different weld strengths, densities, or hardnesses, based on the power level of the energy incident on the particular portion of the metal-forming material.

At block 720 the method 700 can include providing a second layer of the metal-forming material on top of the first portion and the second portion of the metallic structure. Once the first layer (e.g., the first layer 510 or the first layer 610) is hardened or welded by the laser energy, a second layer of the powdered metal can be laid on top of the first layer of the welded metallic structure (e.g., the labyrinth seal 300). The second layer of powdered metal, once welded, can form the second layer (e.g., the second layer 520 or the second layer 620) of, for example, the labyrinth seal 300.

At block 725 the method 700 can include applying the energy of the first power level to a first area of the second layer of metal-forming material. In some examples, this can enlarge the first portion of the first layer.

At block 730, the method 700 can include applying the energy of the second power level to a second area of the second layer of metal-forming material. Similar to block 725, this can also enlarge the second portion of the first layer.

The method 700 can be repeated successively until a desired structure is completed. The method 700 can be used to form the labyrinth seal 300 using successive layers of powdered metal. Each layer of powdered metal can be welded to the preceding layer, enlarging the structure (e.g., the labyrinth seal 300) and improving the method for producing such a component.

One of ordinary skill can appreciate that the method 700 is not confined to creating or forming the shroud seal. Many other components can be formed using a similar process where a composite metallic structure is formed using successive layers of powdered metal. The layers can have specific portions of differently welded material.

### INDUSTRIAL APPLICABILITY

Internal-driven compressors such as those described herein rely on various dry seals to maintain pressurization as the working fluid is compressed. One such dry seal is the labyrinth seal 300 (FIG. 2). The compressor rotor 130 (or other rotating body) can have labyrinth teeth 135 that are a series of circumferential ridges that resemble teeth when viewed from a lateral perspective (see for example, FIG. 2). The labyrinth teeth 135 interact with the open cell structure 312 and/or the media filler 504 within the cavities 314 on the inside of the labyrinth seal 300. The teeth can score indentations in the inner surface of the labyrinth seal 300 creating channels or grooves that complement the size and shape of the labyrinth teeth. This complementary or interlocking relationship of the labyrinth teeth 135 and the grooves in the seal media 310 can produce the long, circuitous path which slows leakage from a high pressure side of the seal to the low pressure side.

One manner of forming such a labyrinth seal 300 (as noted above) is to mill the cylindrical body 302 from a portion of metal, form the open cell structure 312 and braze the open cell structure to the interior of the cylindrical body 302. From there, if the media filler 504 is required, powdered metal is packed within the cavities 314 and the entire structure is baked to harden or weld the media filler 504. A final milling of the completed labyrinth seal 300 may then be required to remove imperfections. This process is complex and expensive.

The methods and devices as disclosed herein can improve the process by directly forming each complex metallic structure in a single step. Powdered metal or other metal-forming material can be subjected to laser energy to weld the powdered metal together. The power level of the incident laser can determine how hard or how strong the welds are. Successive layers of the powdered metal can be laid down over completed layers to expand the structure and complete a given component. The disclosure presents the labyrinth seal 300 as a primary example of how a component comprising parts having different weld strengths or densities can be formed in a single process. This can lead to higher efficiency, lower unit cost, and even stronger components. The skilled person will appreciate that the concepts and methods disclosed herein are not limited to formation of the labyrinth seal 300 and can be used for any number of different components.

Those of skill will appreciate that the various illustrative logical blocks, modules, units, and algorithm steps described in connection with the embodiments disclosed herein can often be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular constraints imposed on the overall system. Skilled persons can implement the described functionality in varying ways for each particular system, but such implementation decisions should not be interpreted as causing a departure from the scope of the invention. In addition, the grouping of functions within a unit, module, block, or step is for ease of description. Specific functions or steps can be moved from one unit, module, or block without departing from the invention.

The preceding detailed description is merely exemplary in nature and is not intended to limit the invention or the application and uses of the invention. The described embodiments are not limited to use in conjunction with a particular type of gas turbine engine. It will be appreciated that the gas turbine engine in accordance with this disclosure can be implemented in various other configurations. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A method for forming a metallic structure having two or more portions, the method comprising:
providing a first layer of metal-forming material;
applying energy of a first power level to a first area of the first layer of metal-forming material to form a first portion of the metallic structure having a first density;
applying energy of a second power level to a second area of the first layer of metal-forming material to form a second portion of the metallic structure having a second density;
providing a second layer of the metal-forming material on top of the first portion and the second portion of the metallic structure;
applying the energy of the first power level to a first area of the second layer of metal-forming material; and
applying the energy of the second power level to a second area of the second layer of metal-forming material.

2. The method claim 1 further comprising applying energy of a third power level to a third portion of the first layer of metal-forming material and the second layer of metal-forming material to form a third portion of the metallic structure having a third density.

3. The method of claim 2 wherein the first portion of the metallic structure is an open cell structure, the second portion of the metallic structure is a filler media within the open cell structure, and the third portion of the metallic structure is a cylindrical body of a labyrinth seal.

4. The method of claim 1 wherein the metallic structure is a labyrinth seal, the first portion of the metallic structure comprises an open cell structure and a cylindrical body of the labyrinth seal, and the second portion of the metallic structure is a filler media within the open cell structure.

5. The method of claim 4, wherein the filler media and the open cell structure comprise an abradable structure operable to interact with labyrinth teeth of a compressor.

6. The method of claim 1 wherein the energy of the first and second power levels is provided by a laser.

7. The method of claim 1 wherein the metallic structure is a labyrinth seal for an internal-driven compressor.

8. The method of claim 1 wherein the metal-forming material is a powdered metal.

9. The method of claim 1 wherein applying the energy of the first power level to the first and second layers of metal-forming material causes a weld of a first weld strength to form between adjacent particles of the metal-forming material, and applying the energy of the second power level to the first and second layers of metal-forming material causes a weld of a second weld strength to form between adjacent particles of the metal-forming material.

10. A method for making a labyrinth seal for use in an internal-driven compressor, the labyrinth seal having a cylindrical body, an integral open cell structure, and a filler media within the open cell structure, the method comprising:
providing a first layer of metallic powder;
applying laser energy of a first power level to a first area of the first layer of metallic powder to form a first portion of the cylindrical body having a first weld strength;
applying laser energy of a second power level to a second area of the first layer of metallic powder to form a first portion of the open cell structure having a second weld strength;
applying laser energy of a third power level to a third area of the first layer of metallic powder to form a first portion of the filler material having a third weld strength;
providing a second layer of metallic powder on top of the first portions of the cylindrical body, the open cell structure, and the filler media;
applying laser energy of the first power level to a first area of the second layer of metallic powder to form a second portion of the cylindrical body;
applying laser energy of the second power level to a second area of the second layer of metallic powder to form a second portion of the open cell structure; and
applying laser energy of the third power level to a third area of the second layer of metallic powder to form a second portion of the filler material.

11. The method claim 10, wherein the first weld strength and the second weld strength are equal.

12. The method of claim 10, wherein the second weld strength and the third weld strength allow the labyrinth seal to score the open cell structure and the filler media to provide a labyrinth seal.

13. A labyrinth seal prepared by a process comprising the steps of:
providing a first layer of metal-forming material;
applying energy of a first power level to a first area of the first layer of metal-forming material to form a first portion of the labyrinth seal having a first density;
applying energy of a second power level to a second area of the first layer of metal-forming material to form a second portion of the labyrinth seal having a second density;
providing a second layer of the metal-forming material on top of the first portion and the second portion of the labyrinth seal;
applying the energy of the first power level to a first area of the second layer of metal-forming material; and
applying the energy of the second power level to a second area of the second layer of metal-forming material.

14. The process of claim 13 wherein the energy of the first and second levels is provided by a laser.

15. The process of claim 13 wherein the metal-forming material is a powdered metal.

16. The process of claim 13 wherein the energy of the first power level and the second power level is provided by a laser.
